(19) United States
(12) Patent Application Publication
(10) Pub. No.: US 2005/0094509 A1
(43) Pub. Date: May 5, 2005

(54) Optical head and optical information recording/reproducing apparatus using same

(75) Inventor: Chihiro Nagura, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/968,996

(22) Filed: Oct. 21, 2004

(30) Foreign Application Priority Data
Oct. 31, 2003 (JP) 2003-372156

(51) Int. Cl. G11B 7/00

(52) U.S. Cl. 369/44.37; 369/44.41

(57) ABSTRACT

An optical head is provided that irradiates an information track in an optical disk with a focusing light to record and/or reproduce information and comprises a first light-receiving surface in which a light reflected from an optical disk is received in an interfering area in which a 0-order diffracted light and ±1-order diffracted lights from the information track interfere with one another, except for a central portion of the interfering area, and a second light-receiving surface in which the reflected light is received in the central portion of the interfering area, each of the first and the second light-receiving surfaces being divided into two regions in the direction of the information track; and an arithmetic circuit for generating a tracking error signal on the basis of a difference between outputs from the two regions into which the first light-receiving surface is divided, and for generating a tilt signal indicating an amount of tilt in the optical disk on the basis of a difference between outputs from the two regions into which the second light-receiving surface is divided.

### BACKGROUND OF THE INVENTION

1. Field of the Invention

The present invention relates to an optical head that optically records and/or reproduces information on or from an optical disk, and an optical information recording/reproducing apparatus using the optical head.

2. Related Background Art

To stably record and/or reproduce information on or from an optical disk, a light spot must be accurately scanned over information tracks in the optical disk. To accomplish this, it is necessary to detect a tracking error in which the light spot is offset with respect to a track center, to perform tracking control on the basis of the result of the detection.

With the recent decrease in the pitch of the optical disk, requirements for the tracking control have become increasingly strict. A push pull process is used as a method for detecting tracking errors (for example, Japanese Patent Application Laid-Open No. H07-141673). The detection of tracking errors based on the push pull process is the most common technique for tracking control.

FIG. 11 shows a configuration of an optical head in a conventional optical information recording/reproducing apparatus that performs tracking control using the push pull process.

As shown in FIG. 11, when a light flux emitted by a light source (not shown) is passed through a collimator lens 100 and then condensed in an information track in an optical disk 400 using an objective lens 200, a light reflected from the optical disk is diffracted by the information track. At this time, in an area in which a 0-order diffracted light overlaps ±1-order diffracted lights, the lights interfere with one another in a far field, so that in this area, a distribution of intensity is formed which corresponds to the position of the light spot on the optical disk 400. With a light-receiving device 300, of the light reflected by the optical disk 400 and then passing through the objective lens 200 and collimator lens 100, that light which is located within the area in which the 0-order diffracted light and the ±1-order diffracted lights interfere with one another is detected by each of two light-receiving surfaces of the light-receiving device 300 divided in the direction of information tracks (tan direction). Then, a differential amplifier 500 provided following the light-receiving device 300 calculates a difference between outputs from the divided two light-receiving surfaces of the light-receiving device 300, and the difference value is set as a tracking error signal. The light-receiving device 300 is commonly a two-element photodiode.

The tracking error signal thus obtained is a periodic signal for which when traversing the information tracks, the light spot zero-crosses in the center of the tracks. On the basis of the tracking error signal, tracking control can be accurately performed so that the light spot is located in the center of the tracks.

However, a problem involved in the push pull process is that an offset may occur in the tracking error signal owing to a shift on the objective lens (hereinafter referred to as a “lens shift”) or a tilt in the optical disk (hereinafter referred to as a “disk tilt”). If an offset occurs in the tracking error signal, detracking may occur in which the position of the light spot may be shifted from the center of the tracks. Consequently, the recording/reproducing performance may be degraded.

In contrast, with a differential push pull process that is an improved push pull process, multiple light fluxes can be used to cancel an offset in the tracking error signal which may be caused by a lens shift or a disk tilt. However, if a tilt is present in the optical disk, the tracking error signal may be distorted. Consequently, the detracking cannot be perfectly inhibited even though the offset is cancelled.

### SUMMARY OF THE INVENTION

The present invention provides an optical head in which tracking control that is less likely to be affected by a disk tilt can be performed without complicating the configuration of the apparatus and an optical information recording/reproducing apparatus using the optical head.

According to a first aspect of the present invention, there is provided an optical head that irradiates an information track in an optical disk with a focusing light to record and/or reproduce information, the optical head comprising:
a first light-receiving surface in which a light reflected from an optical disk is received in an interfering area in which a 0-order diffracted light and ±1-order diffracted lights from the information track interfere with one another, except for a central portion of the interfering area, and a second light-receiving surface in which the reflected light is received in the central portion of the interfering area, each of the first and the second light-receiving surfaces being divided into two regions in the direction of the information track; and
an arithmetic circuit for generating a tracking error signal on the basis of a difference between outputs from the two regions into which the first light-receiving surface is divided, and for generating a tilt signal indicating an amount of tilt in the optical disk on the basis of a difference between outputs from the two regions into which the second light-receiving surface is divided.

According to a second aspect of the present invention, there is provided an optical information recording/reproducing apparatus comprising the optical head.

### BRIEF DESCRIPTION OF THE DRAWINGS

FIG. 1 is a schematic view showing the configuration of an optical head of an optical information recording/reproducing apparatus in accordance with the present invention;

FIG. 2 is a schematic view showing the configuration of a light-receiving device and an arithmetic circuit in accordance with Embodiment 1 of the present invention;

FIG. 3 is a graphical representation showing an amount of tracking offset relative to a tilt in a radial direction of an optical disk;

FIG. 4 is a schematic view showing the configuration of a light-receiving device and an arithmetic circuit in accordance with Embodiment 2 of the present invention;

FIG. 5 is a schematic view showing the configuration of a light-receiving device and an arithmetic circuit in accordance with Embodiment 3 of the present invention;

FIG. 6 is a schematic view showing the configuration of an optical head of an optical information recording/reproducing apparatus in accordance with Embodiment 4 of the present invention;

FIG. 7 is a schematic view showing the configuration of a liquid crystal device in accordance with Embodiment 4 of the present invention;

FIG. 8 is a schematic view showing the configuration of a light-receiving device and an arithmetic circuit in accordance with Embodiment 4 of the present invention;

FIG. 9 is a schematic view showing the configuration of an optical head of an optical information recording/reproducing apparatus in accordance with Embodiment 5 of the present invention;

FIG. 10 is a schematic view showing the configuration of an optical information recording/reproducing apparatus in accordance with Embodiment 5 of the present invention; and

FIG. 11 is a schematic view showing the configuration of a conventional optical information recording/reproducing apparatus.

### DESCRIPTION OF THE PREFERRED EMBODIMENTS

Embodiments of the present invention will be described below in detail with reference to the drawings.

(Embodiment 1)

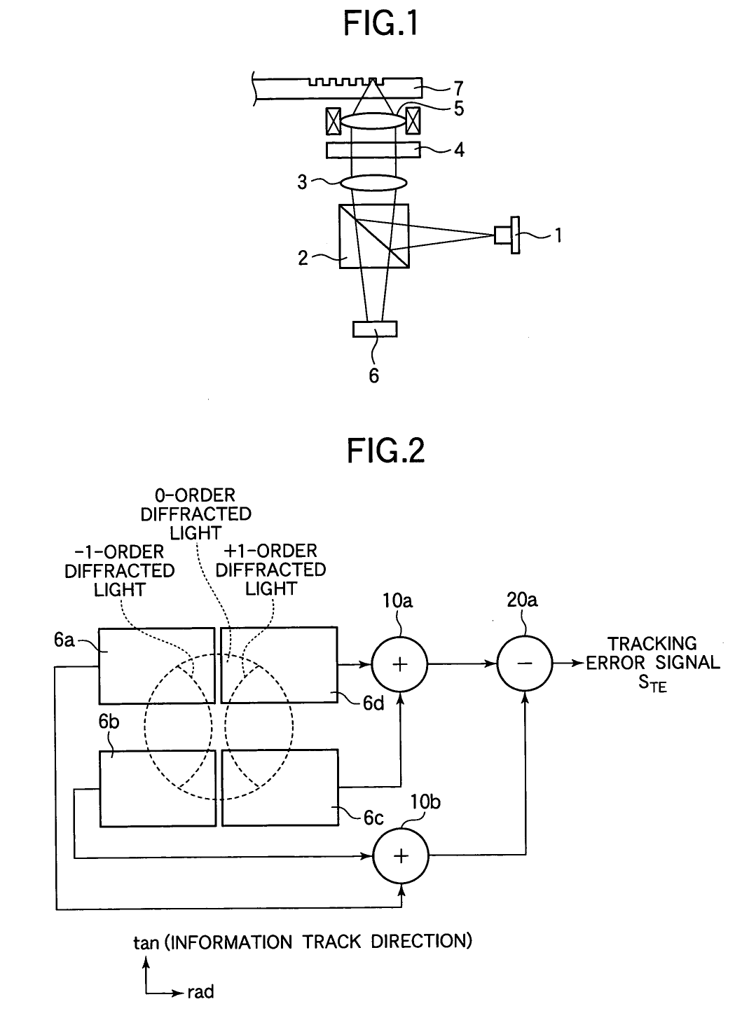

FIG. 1 is a schematic view showing the configuration of an optical head of an optical information recording/reproducing apparatus in accordance with Embodiment 1 of the present invention. The optical head shown in FIG. 1 is composed of a laser light source 1 that is a semiconductor laser source of a wavelength 650 nm, a polarization beam splitter 2, a collimator lens 3, a quarter-wavelength plate 4, an objective lens 5 of NA 0.65, and a light-receiving device 6 and records and/or reproduces information on or from the optical disk 7.

A light flux emitted by the laser light source 1 is reflected by the polarization beam splitter 2. Then, the light flux passes through the collimator lens 3 and the quarter wavelength plate 4. The light flux is then condensed in an information track in the optical disk 7 by using an objective lens 5. The optical disk 7 has a track pitch of 0.64 μm (groove recording) and a groove depth of 20 nm. A reflected light from the optical disk 7 passes through the objective lens 5, the quarter wavelength plate 4, the collimator lens 3, and the polarization beam splitter 2, and is then incident on the light-receiving device 6.

In this case, as shown in FIG. 2, the light-receiving surface of the light-receiving device 6 is divided into a light-receiving surface 6a, 6d and a light-receiving surface 6b, 6c in a direction substantially perpendicular to the direction of the information tracks of the optical disk 7 (tan direction) so as to receive a light reflected from the optical disk 7 in an interfering area in which a 0-order diffracted light and ±1-order diffracted lights overlap one another, except for a central portion of the area. Moreover, the light-receiving surface 6a, 6d is divided into light-receiving surfaces 6a and 6d substantially in the direction of the information tracks, and the light-receiving surface 6b, 6c is also divided into light-receiving surfaces 6b and 6c.

As shown in FIG. 2, outputs from the light-receiving surfaces 6a, 6b, 6c and 6d are used for a calculation executed by an arithmetic circuit provided following the light-receiving device 6. The calculation generates a tracking error signal S_{TE}. Specifically, when outputs from the light-receiving surfaces 6a, 6b, 6c and 6d are defined as A, B, C and D, summing amplifiers 10a and 10b and a differential amplifier 20a execute a calculation shown by the following Equation 1, to provide a tracking error signal S_{TE}.
S_{TE}=(A+B)−(C+D) [Equation 1]

Next, description will be given of the case where the optical disk 7 is tilted in a radial direction (rad direction) to an objective lens 5. In this case, coma aberration may occur in the reflected light from the optical disk, affecting notably the central portion of the area in which the 0-order diffracted light and the ±1-order diffracted lights interfere with one another.

However, in the present embodiment, a tracking error signal S_{TE} is generated in the state in which the light-receiving surface of the light-receiving device 6 is disposed such that the reflected light from the optical disk 7 is not received in the central portion of the area in which the 0-order diffracted light and the ±1-order diffracted lights interfere with one another. Accordingly, the generated tracking error signal S_{TE} is not significantly affected by wave-front aberration attributed to coma.

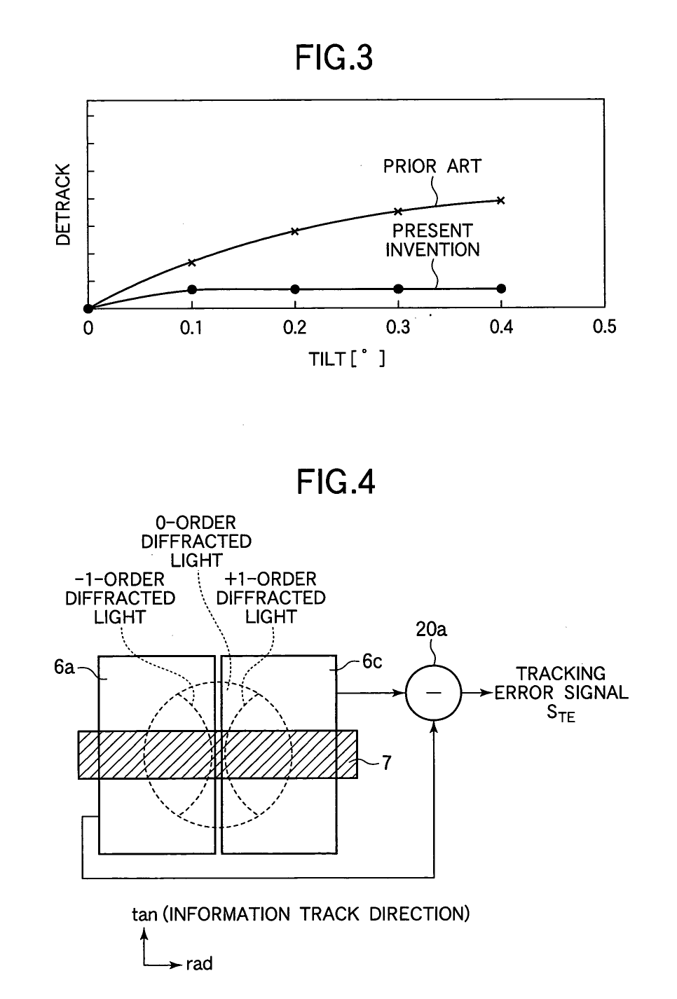

FIG. 3 shows calculated values for a variation in the amount of detracking relative to a disk tilt in the radial direction.

It can be seen from FIG. 3 that the optical head in accordance with the present embodiment can remarkably suppress the amount of detracking as compared to the prior art using the two-element photodiode.

As described above, the present embodiment can suppress the generation of detracking resulting from a disk tilt without increasing the number of parts such as a mask. This makes it possible to perform tracking control that is less likely to be affected by a disk tilt. Further, the light-receiving surface pattern in accordance with the present embodiment can be easily utilized for detection of a focus signal based on the well-known astigmatism method.

(Embodiment 2)

The device configuration of the optical head and the process of guiding a light flux to the light-receiving device 6 in accordance with the present embodiment are similar to those in accordance with Embodiment 1. However, the configurations of the light-receiving device 6 and arithmetic circuit in accordance with the present embodiment are different from those in accordance with Embodiment 1.

In Embodiment 1, the light-receiving surface of the light-receiving device 6 is divided into two in a direction substantially perpendicular to the direction of the information tracks of the optical disk 7 such that the light reflected from the optical disk is not received in the central portion of the area in which the 0-order diffracted light and the ±1-order diffracted lights interfere with one another. In contrast, in the present embodiment, as shown in FIG. 4, by providing a mask 7 that shields the central portion of the area in which the 0-order diffracted light and the ±1-order diffracted lights interfere with one another in an optical path, the reflected light from the optical disk 7 is prevented from being received in the central portion of the interfering area. In this case, it suffices to divide the light-receiving surface of the light-receiving device 6 into the light-receiving surfaces 6a and 6c substantially in the direction of the information tracks. Further, in this case, when the outputs from the light-receiving surfaces 6a and 6c are defined as A and C, a differential amplifier 20a provided following the light-receiving device 6 executes a calculation shown by the Equation 2 below to provide a tracking error signal S_{TE}.
S_{TE}=A−C [Equation 2]

In the present embodiment, because a tracking error signal S_{TE} is generated in the state in which the mask 7 is provided such that the reflected light from the optical disk 7 is not received in the central portion of the area in which the 0-order diffracted light and the ±1-order diffracted lights interfere with one another. Consequently, the generated tracking error signal S_{TE} is not significantly affected by wave-front aberration attributed to coma, as is the case with Embodiment 1.

Therefore, the present embodiment can suppress the generation of detracking caused by a disk tilt, so that it is possible to perform tracking control that is less likely to be affected by a disk tilt. Further, as compared to Embodiment 1, it is possible to perform tracking control that is less likely to be affected by a disk tilt using the light-receiving device and arithmetic circuit that are simpler than those of Embodiment 1.

(Embodiment 3)

The device configuration of the optical head and the process of guiding a light flux to the light-receiving device 6 in accordance with the present embodiment are similar to those in accordance with Embodiment 1. However, the configurations of the light-receiving device 6 and arithmetic circuit in accordance with the present embodiment are different from those in accordance with Embodiment 1.

The light-receiving surface of the light-receiving device 6 is divided, in a direction substantially perpendicular to the direction (tan direction) of the information tracks of the optical disk 7, into a light-receiving surface 6a, 6d and a light-receiving surface 6b, 6c as the first light-receiving surface in which the reflected light from the optical disk 7 is received in the interfering area in which the 0-order diffracted light and the ±1-order diffracted lights interfere with one another, except for the central portion of the interfering area, and a light-receiving surface 6e, 6f as the second light-receiving surface in which the reflected light from the optical disk 7 is received in the central portion of the interfering area. Moreover, substantially in the direction of the information tracks, the light-receiving surface 6a, 6d is divided into light-receiving surfaces 6a and 6d; the light-receiving surface 6e, 6f is divided into light-receiving surfaces 6e and 6f; and the light-receiving surface 6b, 6c is divided into light-receiving surfaces 6b and 6c.

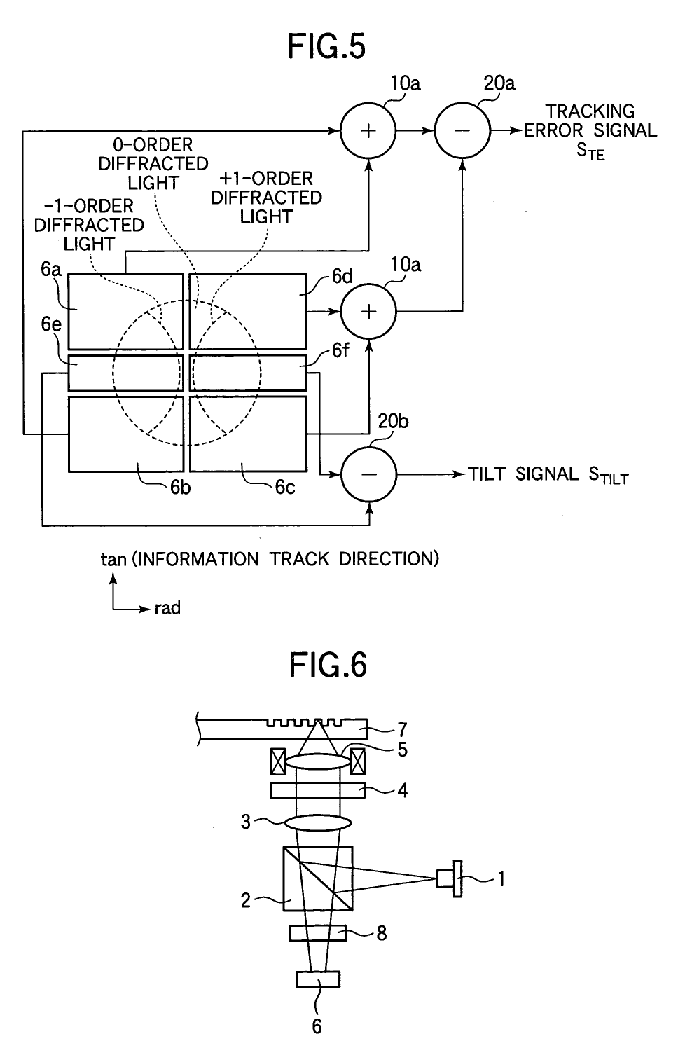

Outputs from the light-receiving surfaces 6a, 6b, 6c, 6d, 6e, and 6f are used for a calculation executed by an arithmetic circuit provided following the light-receiving device 6, as shown in FIG. 5. The calculation generates a tracking error signal S_{TE} and a tilt signal S_{TILT}. Specifically, when the outputs from the light-receiving surfaces 6a, 6b, 6c, 6d, 6e and 6f are defined as A, B, C, D, E and F, the summing amplifiers 10a and 10b and the differential amplifiers 20a and 20b execute calculations shown in Equations 3 and 4 below to provide a tracking error signal S_{TE} and a tilt signal S_{TILT}.
S_{TE}=(A+B)−(C+D) [Equation 3]
S_{TILT}=E−F [Equation 4]

In the present embodiment, because the tracking error S_{TE} is generated on the basis of the output from the area in which the 0-order diffracted light and the ±1-order diffracted lights interfere with one another of the light-receiving surface of the light-receiving element 6, except for the central portion of the area, the generated tracking error signal S_{TE} is not significantly affected by wave-front aberration attributed to coma as in the case with Embodiments 1 and 2. Further, because optical interference is utilized to generate a tilt signal S_{TILT} on the basis of the output from the central portion of the area in which the 0-order diffracted light and the ±1-order diffracted lights interfere with one another, the generated tilt signal S_{TILT} indicates the amount of tilt in the optical disk 7 with a very high accuracy.

Therefore, generation of detracking due to a disk tilt can be suppressed without increasing the number of parts such as a mask, thus making it possible to perform tracking control that is not affected by a disk tilt. At the same time, a tilt signal can be obtained which indicates the amount of tilt in the optical disk 7 with a high accuracy.

(Embodiment 4)

FIG. 6 shows the configuration of an optical head in an optical information recording/reproducing apparatus in accordance with Embodiment 4 of the present invention. The optical head shown in FIG. 6 is composed of a laser light source 1 that is a semiconductor laser source of a wavelength 650 nm, a polarization beam splitter 2, a collimator lens 3, a quarter wavelength plate 4, an objective lens 5 of NA 0.65, a light-receiving device 6, and a liquid crystal device 8 that is a light-receiving device and records and/or reproduces information on or from the optical disk 7.

A light flux emitted by the laser light source 1 is reflected by the polarization beam splitter 2, then passes through the collimator lens 3 and the quarter wavelength plate 4, and is then condensed in an information track in the optical disk 7 by using the objective lens 5. The optical disk 7 has a track pitch of 0.64 μm (groove recording) and a groove depth of 20 nm. A reflected light from the optical disk 7 passes through the objective lens 5, the quarter wavelength plate 4, the collimator lens 3, the polarization beam splitter 2, and the liquid crystal device 8, and is then incident on the light-receiving device 6.

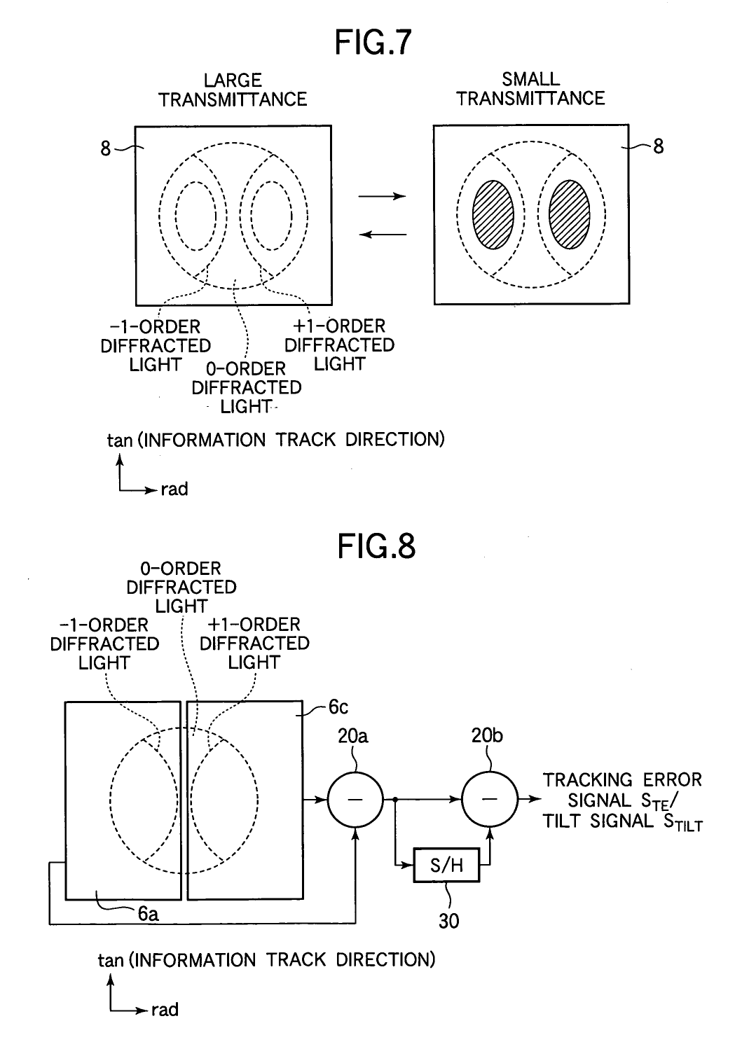

In this case, the liquid crystal device 8 consists of a liquid crystal cell and a polarization plate and is configured such that the transmittance of a region of a liquid crystal electrode pattern is changed in accordance with an electric on/off signal. More specifically, as shown in FIG. 7, it is possible to change the transmittance of the central portion of the area in which the 0-order diffracted light and the ±1-order diffracted lights interfere with one another.

As shown in FIG. 8, the light-receiving surface of the light-receiving device 6 is divided into light-receiving surfaces 6a and 6c in the direction of the information tracks.

Outputs from the light-receiving surfaces 6a and 6c are used, as shown in FIG. 8, for a calculation executed by an arithmetic circuit provided following the light-receiving device 6, and the calculation generates a tracking error signal S_{TE} and a tilt signal S_{TILT}. Specifically, when outputs from the light-receiving surfaces 6a and 6c in the case of the transmittance of the liquid crystal device 8 being large are defined as A1 and C1, respectively, and outputs from the light-receiving surfaces 6a and 6c in the case of the transmittance of the liquid crystal device 8 being small are defined as A2 and C2, respectively, the differential amplifiers 20a and 20b and a sample hold (S/H) circuit 30 execute calculations shown by Equations 5 and 6 below to provide a tracking error signal S_{TE} and a tilt signal S_{TILT}.
S_{TE}=A2−C2 [Equation 5]
S_{TILT}=(A1−C1)−(A2−C2)=(A1−A2)−(C1−C2) [Equation 6]

Specifically, first, the liquid crystal device 8 is set to have a small transmittance. Further, Equation 5 is used to calculate the difference “A2−C2” between the outputs from the light-receiving surfaces 6a and 6c, and the value obtained is defined as a tracking error signal S_{TE}. The thus obtained value “A2−C2” is held in a sample hold circuit 30. Subsequently, the transmittance of the liquid crystal device 8 is switched from the small transmittance to a large transmittance, and Equation 6 is then used to calculate the difference “(A1−C1)−(A2−C2)” between the difference “A1−C1” between the outputs from the light-receiving surfaces 6a and 6c at that time and the value “A2−C2”, held in the sample hold circuit 30 to provide the resultant value as a tilt signal S_{TILT}.

In the present embodiment, because a tracking error signal S_{TE} is generated in the state in which the transmittance of the liquid crystal element 8 is set to so small that the light is less likely to be received in the central portion of the area of the light-receiving surface of the light-receiving device 6 in which the 0-order diffracted light and the ±1-order diffracted lights interfere with one another. Consequently, the generated tracking error signal S_{TE} is not significantly affected by wave-front aberration attributed to coma as is the case with Embodiments 1 to 3. Further, because optical interference is utilized to generate a tilt signal S_{TILT} on the basis of the difference between the outputs from the central portion of the area in which the 0-order diffracted light and the ±1-order diffracted lights interfere with one another, as obtained when the transmittance of the liquid crystal device 8 is changed, the generated tilt signal S_{TILT} indicates the amount of tilt in the optical disk 7 with a very high accuracy. Furthermore, the common arithmetic circuit can be used to obtain both a tracking error signal S_{TE} and a tilt signal S_{TILT}.

Therefore, generation of detracking due to a disk tilt can be suppressed, thus making it possible to perform tracking control that is not affected by a disk tilt. At the same time, a tilt signal can be obtained which accurately indicates the amount of tilt in the optical disk 7. Further, tracking control that is less likely to be affected by a disk tilt can be performed using the light-receiving device and arithmetic circuit that are simpler than those of Embodiment 3.

(Embodiment 5)

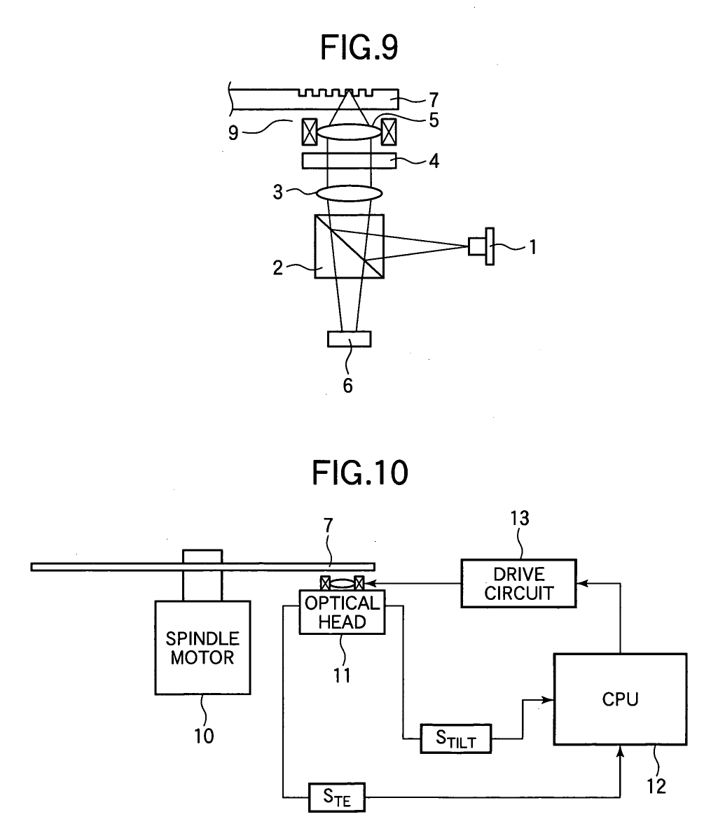

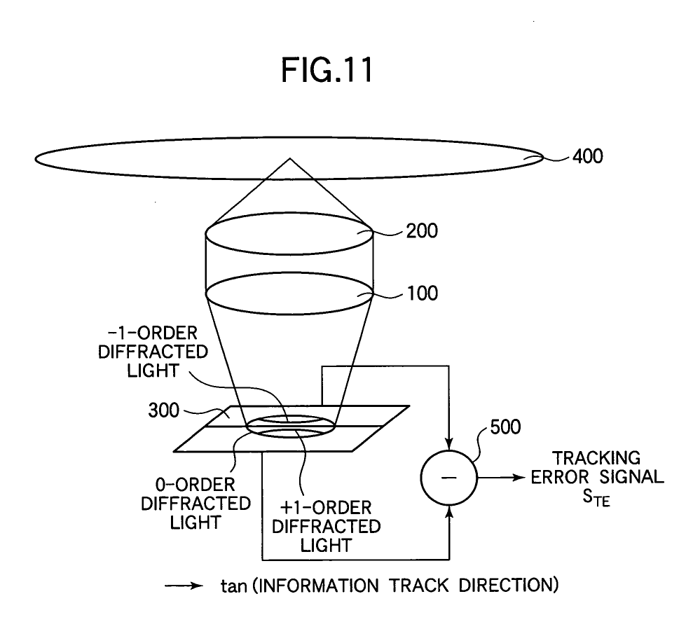

FIG. 9 shows the configuration of an optical head in accordance with Embodiment 5 of the present invention. The optical head is composed of a laser light source 1 that is a semiconductor laser source of a wavelength 650 nm, a polarization beam splitter 2, a collimator lens 3, a quarter wavelength plate 4, an objective lens 5 of NA 0.65, and a light-receiving device 6 and records and/or reproduces information on or from the optical disk 7.

A light flux emitted by the laser light source 1 is reflected by the polarization beam splitter 2, then passes through the collimator lens 3 and the quarter wavelength plate 4, and is then condensed in an information track in the optical disk 7. The optical disk 7 has a track pitch of 0.64 μm (groove recording) and a groove depth of 20 nm. A reflected light from the optical disk 7 passes through the objective lens 5, the quarter wavelength plate 4, the collimator lens 3, and the polarization beam splitter 2, and is then incident on the light-receiving device 6. The light-receiving surface of the light-receiving device 6 is similar to that of Embodiment 3, shown in FIG. 5. An actuator 9 for driving the objective lens 5 can perform a translation action in the direction of the optical axis and in the radial direction and a tilting action in the radial direction.

FIG. 10 schematically shows the configuration of an optical information recording/reproducing apparatus in accordance with Embodiment 5 of the present invention. An optical disk 7, which records and reproduces information, is set on a spindle motor 10 and rotates while being irradiated with a focusing light from the optical head 11. The outputs from the light-receiving device 6 of the optical head 11 are subjected to calculation according to Equations 7 and 8 shown below to detect a tracking error signal S_{TE} and a tilt signal S_{TILT} in the same manner as described for Embodiment 3.
S_{TE}=(A+B)−(C+D) [Equation 7]
S_{TILT}=E−F [Equation 8]

On the basis of the tracking error signal S_{TE}, a CPU 12 generates a drive signal. A drive circuit 13 then drives the actuator 9 in the radial direction. Further, on the basis of the tilt signal S_{TILT}, the CPU 12 generates a drive signal. The drive circuit 13 then drivingly tilts the actuator 9. Recording/reproduction of information is carried out while controlling the actuator in the above manner.

With the optical information recording/reproducing apparatus in accordance with the present embodiment, it is possible to suppress generation of detracking due to a disk tilt, thus performing tracking control that is not affected by a disk tilt. At the same time, the amount of tilt of the optical disk 7 can be highly accurately corrected to enable stable recording/reproduction.

This application claims priority from Japanese Patent Application No. 2003-372156 filed Oct. 31, 2003, which is hereby incorporated by reference herein.

1. An optical head that irradiates an information track in an optical disk with a focusing light to record and/or reproduce information, the optical head comprising:
a first light-receiving surface in which a light reflected from an optical disk is received in an interfering area in which a 0-order diffracted light and ±1-order diffracted lights from the information track interfere with one another, except for a central portion of the interfering area, and a second light-receiving surface in which the reflected light is received in the central portion of the interfering area, each of the first and the second light-receiving surfaces being divided into two regions in the direction of the information track; and
an arithmetic circuit for generating a tracking error signal on the basis of a difference between outputs from the two regions into which the first light-receiving surface is divided, and for generating a tilt signal indicating an amount of tilt in the optical disk on the basis of a difference between outputs from the two regions into which the second light-receiving surface is divided.

2. The optical head according to claim 1, wherein a single light-receiving device comprises the first light-receiving surface and the second light-receiving surface.

3. The optical head according to claim 1, wherein the first light-receiving surface is placed on both sides of the second light-receiving surface.

4. An optical information recording/reproducing apparatus that irradiates an information track in an optical disk with a focusing light to record and/or reproduce information, the apparatus comprising:
an objective lens for emitting a focusing light;
an actuator for performing tilting and tracking of the objective lens;
a first light-receiving surface in which a light reflected from an optical disk is received in an interfering area in which a 0-order diffracted light and ±1-order diffracted lights from the information track interfere with one another, except for a central portion of the interfering area, and a second light-receiving surface in which the reflected light is received in the central portion of the interfering area, each of the first and the second light-receiving surfaces being divided into two regions in the direction of the information track;
an arithmetic circuit for generating a tracking error signal on the basis of a difference between outputs from the two regions into which the first light-receiving surface is divided, and for generating a tilt signal indicating an amount of tilt in the optical disk on the basis of a difference between outputs from the two regions into which the second light-receiving surface is divided; and
a drive means for driving the actuator on the basis of the generated tilt signal and tracking error signal.
